(19) United States
(12) Patent Application Publication
(10) Pub. No.: US 2008/0193369 A1
(43) Pub. Date: Aug. 14, 2008

(54) Process for Producing High Porosity Boehmite Aluminas

(76) Inventors: David A. Barclay, Lake Charles, LA (US); Mark M. Chavez, Lake Charles, LA (US)

Correspondence Address: C. JAMES BUSHMAN, 5718 WESTHEIMER, SUITE 1800, HOUSTON, TX, 77057, US

(21) Appl. No.: 11/997,450

(22) PCT Filed: May 23, 2006
(86) PCT No.: PCT/US06/19907

§ 371 Date: Jan. 31, 2008

Related U.S. Application Data
(60) Provisional application No. 60/711,295, filed on Aug. 25, 2005.

(51) Int. Cl. C01F 7/02

(52) U.S. Cl. 423/628

(57) ABSTRACT

A method for producing high porosity boehmite alumina wherein an aqueous boehmite slurry is mixed with an effective amount of a modifier comprising a hydroxide or oxide of an element of group IIIA-VIA on the Periodic Table of Elements and having a pKsp of greater than 11 to produce a precursor mixture and hydrothermally aping the precursor mixture at an elevated temperature under agitation with an effective consumptive power of greater than 1 kW/m³.

### CROSS REFERENCE TO RELATED APPLICATION

This application claims the priority of U.S. Provisional Application No. 60/711,295 filed on Aug. 25, 2005, the disclosure of which is incorporated herein by reference for all purposes.

### BACKGROUND OF THE INVENTION

1. Field of the Invention

The present invention relates to a process for producing boehmite aluminas and, more specifically, to a process for producing high porosity boehmite aluminas.

2. Description of Prior Art

U.S. Pat. No. 6,048,470 discloses an alumina sol of high transparency and porosity, the alumina sol being prepared by stirring a dispersion of an alumina hydrate having a solids content of from 1 to 40 wt. % at a pH of from 7 to 12 with an effective consumptive power of at least 0.5 kW/m³ for aggregation, and then adding an acid for peptization. The process preferably includes the addition of a base, preferably a water soluble base such as an alkali metal hydroxide, to adjust the pH of the alumina hydrate dispersion to the desired pH range.

EP 0934905 discloses a process for producing a boehmite alumina wherein an alumina hydrate is dispersed in an acidic solution at a pH of about 3 to 4. The acidic dispersion is adjusted to a pH of 10 with an alkaline reagent such as sodium aluminate, sodium hydroxide, potassium hydroxide or the like. The dispersion is then heated to 80EC and stirred for a period of 4-20 hours following which the pH level is adjusted to 8 with an acidic reagent to prepare a colloidal sol.

High surface area gamma aluminas which are produced from boehmite aluminas are commonly used as catalyst supports. For example, catalysts comprising relatively small amounts of precious metals deposited on high surface gamma aluminas are commonly used in catalytic converters for the auto industry. Increasingly, the catalytic converters are being placed closer and closer to the engine exhaust to more quickly reduce emissions. This close proximity to the engine exhaust subjects the catalyst to higher operating temperatures requiring that the support, e.g., the gamma alumina, be stable, i.e., retains a high amount of surface area and does not convert to alpha-alumina, at these higher temperatures.

### SUMMARY OF THE INVENTION

In one aspect, the present invention provides a process for producing a high porosity boehmite alumina. In a preferred embodiment of the process, an aqueous boehmite alumina slurry is mixed with, prior to and/or during a hydrothermal aging step, a modifier or additive comprising a water insoluble hydroxide or oxide of an element of Group IIIA-VIII of the Periodic Table of Elements. The hydrothermal aging is preferably conducted at a temperature in the range of 100-160EC, more preferably at 130-160EC, under agitation with an effective consumptive power of greater than 1 kW/m³, preferably from 5-12 kW/m³. Aging (residence) times in the aging step can range from 1 hour to 24 hours. The pH of the slurry during the hydrothermal aging will range from 8 to 10 and the modifier is one which has a pKsp of greater than about 11 and does not alter the pH, either of the feed slurry or of the product from hydrothermal aging step.

In another preferred aspect of the present invention, the above process is carried out using certain insoluble or sparingly soluble hydroxides or oxides of metals which impart enhanced thermal stability when the boehmite aluminas are converted to gamma aluminas. While it is known that the thermal stability of gamma aluminas is enhanced by high porosity, the addition of certain metal dopants further enhances this thermal stability.

The process of the present invention can produce boehmite aluminas of comparable crystal size, morphology and porosity as many commercially available aluminas using much shorter hydrothermal aging (residence) times than are conventionally used.

A feature of the present invention is that the metal oxides and hydroxides which are added to the feed slurry of alumina to be hydrothermally aged cause little to no effect on the pH of the slurry, i.e., there is no change in pH sufficient to change reaction conditions. This is desirable as it is known that highly soluble basic materials such as potassium hydroxide, sodium hydroxide, etc. can result in undesirable thickening of the slurry requiring either that the hydrothermal aging be conducted at high temperatures and/or dilution of the slurry to reduce viscosity.

A further feature of the present invention is the finding that by using the additives of the present invention in combination with high agitation energy, e.g., greater than about 8 kWm³ the porosity that is achieved is much greater than what can be obtained without the additive. Effectively, a synergistic effect exists between the use of the additives of the present invention and effective energy consumption.

According to an especially preferred embodiment of the present invention, it has been found that the addition of 0.1 to 5% wt., based on alumina content of the slurry, of certain insoluble or sparingly soluble metal oxides or hydroxides (modifiers) to the alumina slurry charged to a reactor for hydrothermal treatment reduces the residence time for achieving desired crystallite size and high porosity. Further since such modifiers do not have any appreciable effect on the pH of the slurry, the viscosity of the slurry is unaltered.

### BRIEF DESCRIPTION OF THE DRAWINGS

FIG. 1 is a graph showing the effect of various additives on crystallite growth of alumina.

FIG. 2 is a graph showing the effect of various additives on total pore volume.

FIG. 3 is a graph showing a comparison of the effect of KOH and aluminum oxide/hydroxide on crystallite growth.

FIG. 4 is a graph showing a comparison of the effect of KOH and aluminum oxide/hydroxide on total pore volume.

FIG. 5 is a graph showing a comparison of using aluminum hydroxide with medium porosity alumina and normal aluminas.

FIG. 6 is a graph comparing KOH and aluminum hydroxide on pore volume.

FIG. 7 is a graph showing a comparison of KOH and aluminum oxide/hydroxide on pore volume.

FIG. 8 is a bar graph comparing residual surface areas of prior art, doped aluminas and aluminas made in accordance with the present invention.

FIG. 9 is a graph comparing the viscosity of aluminas made using soluble and insoluble hydroxides.

### DESCRIPTION OF PREFERRED EMBODIMENTS

It has been found that when certain insoluble hydroxides or oxides of certain elements are added to a feed slurry of boehmite alumina prior to hydrothermal aging and/or to such a feed slurry which is being hydrothermally aged, crystallite growth is accelerated, the hydrothermal aging or residence time necessary to achieve a desired crystallite size is reduced and, in the case of certain modifiers, the aluminas produced exhibit exceptional thermal stability when converted to the gamma form.

The amount of modifier or additives employed in the process of the present invention will generally range from about 0.1 to 5 wt. % of the alumina charged to the reactor in which the hydrothermal aging is conducted. A feature of the modifiers of the present invention is that their addition does not alter the pH of the slurry or the product produced thereby. Additionally, as compared to a process wherein a soluble hydroxide e.g., potassium hydroxide, is employed, such as is done in the prior art, the process of the present invention employing the modifiers does not alter the viscosity of the slurry. In the case of soluble, basic materials such as the alkali metal hydroxides, which do result in increased viscosity and concomitant thickening of the slurry, low aging temperatures cannot be used. Further, in certain cases using these soluble alkali metal hydroxides it is also necessary to dilute the slurry to permit processing because of such high viscosity.

It is known that soluble, basic hydroxides such as the alkali metal hydroxides do enhance the rate of crystallite growth and porosity development under hydrothermal aging conditions conducted with agitation. However, the use of these soluble basic materials increases the pH of the slurry with the result, as noted above, that the slurry may become unprocessable due to high viscosity. Furthermore, alkali metal hydroxides such as potassium and sodium hydroxide are catalytically undesirable metals and the alumina dispersions made using them tend to have high dispersion viscosities due to the effect of the metal ions in solution. Although basic materials such as ammonium hydroxide do not result in this effect since the ammonia is removed when the process slurry is dried, the ammonia does present an air emission problem.

All of the above problems of using water soluble hydroxides are eliminated by using the modifiers of the present invention while still achieving the desired acceleration of crystallite growth and enhanced porosity. The alumina product produced according to the present invention is highly dispersible in water.

The process of the present invention employs an aqueous slurry of a boehmite alumina containing from about 9 to about 12 wt. % alumina, calculated as Al₂O₃. In general, the process is conducted at a temperature of from 100-160EC, preferably from 130-160EC. The process is conducted with agitation at a consumptive power input of greater than 1 kW/m³, more preferably from 5-12 kW/m³. In the process, from 0.1 to 5 wt. %, based on the weight of the alumina in the slurry, of the modifier of the present invention is added, either to the feed slurry to the reactor or to the slurry being aged in the reactor. Hydrothermal aging is generally conducted for a period of from 1-24 hours, preferably from 2 to 6 hours. Generally, the pH of the slurry will range from about 8 to about 10 and, as pointed out above, the modifiers of the present invention do not alter the pH of the slurry in terms of changing reaction conditions.

The modifiers of the present invention are water insoluble or sparingly soluble hydroxides and/or oxides of Group IIIA-VIII of the Periodic Table of Elements. Generally speaking, the modifiers employed will have a pKsp of greater than about 11. As noted, unlike water soluble hydroxides and other basic materials used in prior art processes, the modifiers of the present invention do not alter the pH, either of the feed slurry or of the product produced from the hydrothermal aging step. Generally, using the modifier of the present invention, the pH of the slurry will not be effected by more than about 0.2 pH units and in the case of most modifiers, the pH change is even less. In any event, the modifiers of the present invention cannot be considered as pH altering additives of the type used in the prior art processes. Stated differently, the modifiers of the present invention do not have any pH effect that could be considered to alter the reaction conditions, a necessary requirement of typical pH modifiers used in prior art processes. Non-limiting examples of modifiers useful in the process of the present invention include aluminum hydroxide, aluminum trihydrate, lanthanum hydroxide, lanthanum oxide, cerium hydroxide, etc. In particular, the use of lanthanum hydroxide produces a product which can be converted to a gamma alumina exhibiting enhanced temperature stability.

The alumina used in the feed slurry of the present invention can be derived from a variety of sources. In particular, a boehmite alumina obtained from the hydrolysis of an aluminum alkoxide is preferred although boehmite aluminas derived from other sources can be used as well.

To demonstrate the present invention, the following, non-limiting examples are presented.

### Example 1

A series of runs were made on various aqueous alumina slurries where no modifier, soluble or insoluble, was employed in the hydrothermal aging. The aqueous alumina slurries contained 12 wt. % boehmite alumina produced from the hydrolysis of aluminum alkoxides. In all cases, the hydrothermal aging was conducted with stirring at an effective consumptive power of 8.3 kW/m³ (agitator speed of 600 rpm). The reactor employed was a 5 gallon, laboratory reactor, and was operated in a batch mode although the process can be conducted in a continuous mode if desired. The results are shown in Table 1 below:

TABLE 1

| | | | | | | | Crystallite | | Calcined at | | Calcined at | |
|---|---|---|---|---|---|---|---|---|---|---|---|---|
| | Aging | | | Agitator | | | Size | | 1200° C./4 hrs | | 1200° C./24 hrs | |
| | Time | | Temp | Speed | Surface | Pore | Angstroms | | SA | PV | SA | PV |
| Test | hours | Modifier | ° C. | rpm | Area m²/g | Volume ml/g | 020 | 120 | m²/g | ml/g | m²/g | ml/g |
| A | 6 | None | 90 | 600 | 231 | 0.785 | 80 | 81 | | | | |
| B | 8 | None | 90 | 600 | 230 | 0.803 | 76 | 79 | | | | |
| C | 24 | None | 90 | 600 | 206 | 0.985 | 117 | 107 | | | | |
| D | 6 | None | 130 | 600 | 183 | 0.631 | 78 | 111 | 39 | 0.258 | 8 | 0.193 |
| D | 6 | None | 130 | 600 | 217 | 0.6145 | 59 | 89 | 45 | 0.242 | 24 | 0.181 |
| F | 24 | None | 130 | 600 | 134 | 1.031 | 184 | 179 | 70 | 0.849 | 60 | 0.695 |

### Example 2

The procedure of Example 1 was followed with the exception that various water soluble as well as water insoluble modifiers of the present invention were employed. The results are shown in Table 2 below:

TABLE 2

| | | | | | | Crystallite | | | |
|---|---|---|---|---|---|---|---|---|---|
| | Aging | | | | | Size | | Surface | Pore |
| Test | Time | Wt. % | Water Solubility of | | Temp. | Angstroms | | Area | Volume |
| ID | hours | Modifier | Modifier | Modifier | ° C. | 020 | 120 | m2/g | ml/g |
| 1 | 24 | 5.0 | Soluble | Ammonium Carbonate | 130 | 168 | 156 | 151 | 1.129 |
| 2 | 6 | 5.0 | Soluble | Ammonium Carbonate | 130 | 99 | 122 | 180 | 0.842 |
| 3 | 6 | 5.0 | Soluble | Ammonium Hydroxide | 130 | 175 | 181 | 140 | 0.963 |
| 4 | 6 | 1.0 | Soluble | Cesium Hydroxide | 130 | 129 | 144 | 154 | 0.950 |
| 5 | 6 | 1.0 | Soluble | Potassium Hydroxide | 130 | 202 | 183 | 141 | 1.040 |
| 6 | 24 | 2.5 | Soluble | Potassium Hydroxide | 130 | 332 | 229 | 124 | 0.992 |
| 7 | 6 | 2.5 | Soluble | Potassium Hydroxide | 130 | 228 | 173 | 138 | 0.882 |
| 8 | 6 | 5.0 | Soluble | Potassium Hydroxide | 130 | 258 | 186 | 123 | 0.954 |
| 9 | 6 | 1.0 | Soluble | Rubidium Hydroxide | 130 | 123 | 146 | 159 | 0.945 |
| 10 | 6 | 1.0 | Soluble | Sodium Hydroxide | 130 | 213 | 175 | 141 | 1.040 |
| 11 | 6 | 2.5 | Soluble | Sodium Hydroxide | 130 | 263 | 224 | 110 | 0.929 |
| 12 | 6 | 5.0 | Soluble | Sodium Hydroxide | 130 | 251 | 197 | 114 | 0.936 |
| 13 | 6 | 5.0 | Partially Soluble | Calcium Hydroxide | 130 | 64 | 105 | 198 | 0.714 |
| 14 | 6 | 1.0 | Partially Soluble | Lithium Hydroxide | 130 | 165 | 172 | 141 | 0.942 |
| 15 | 6 | 1.0 | Insoluble | Aluminum Hydroxide | 130 | 145 | 151 | 149 | 1.079 |
| 16 | 4 | 1.0 | Insoluble | Aluminum Hydroxide | 130 | 109 | 139 | 161 | 0.902 |
| 17 | 4 | 1.0 | Insoluble | Aluminum Hydroxide | 130 | 119 | 144 | 165 | 0.870 |
| 18 | 6 | 1.0 | Insoluble | Aluminum Hydroxide | 130 | 125 | 148 | 156 | 0.917 |
| 19 | 4 | 5.0 | Insoluble | Aluminum Hydroxide | 130 | 99 | 131 | 167 | 0.876 |
| 20 | 4 | 1.0 | Insoluble | Aluminum hydroxide - dried gel 80% | 130 | 124 | 141 | 156 | 0.951 |
| 21 | 4 | 1.0 | Insoluble | Aluminum hydroxide - gel 19.7% | 130 | 134 | 144 | 152 | 0.951 |
| 22 | 24 | 1.0 | Insoluble | Aluminum hydroxide - gel 19.7% | 130 | 198 | 194 | 133 | 1.100 |
| 23 | 4 | 1.0 | Insoluble | Aluminum Trihydrate (Hydral 710) | 130 | 145 | 149 | 151 | 1.070 |
| 24 | 4 | 1.0 | Insoluble | Aluminum Trihydrate Alcan | 130 | 117 | 145 | 156 | 0.835 |
| 25 | 6 | 1.0 | Insoluble | Cerium Hydroxide | 130 | 114 | 144 | 156 | 0.819 |
| 26 | 24 | 0.5 | Insoluble | Lanthanum hydroxide | 130 | 183 | 184 | 138 | 1.040 |
| 27 | 6 | 0.5 | Insoluble | Lanthanum hydroxide | 130 | 137 | 149 | 154 | 0.926 |
| 28 | 24 | 0.5 | Insoluble | Lanthanum hydroxide | 130 | 183 | 184 | 138 | 1.040 |
| 29 | 24 | 1.0 | Insoluble | Lanthanum hydroxide | 130 | 119 | 163 | 153 | 0.813 |
| 30 | 6 | 1.0 | Insoluble | Lanthanum hydroxide | 130 | 116 | 146 | 154 | 0.905 |
| 31 | 6 | 1.0 | Insoluble | Lanthanum hydroxide | 130 | 126 | 148 | 159 | 0.877 |
| 32 | 6 | 1.0 | Insoluble | Lanthanum hydroxide | 130 | 122 | 155 | 155 | 0.870 |
| 33 | 6 | 1.0 | Insoluble | Lanthanum hydroxide | 130 | 134 | 148 | 156 | 0.957 |
| 34 | 6 | 1.0 | Insoluble | Lanthanum hydroxide | 130 | 144 | 155 | 148 | 1.017 |
| 35 | 6 | 1.0 | Insoluble | Lanthanum hydroxide | 130 | 132 | 153 | 145 | 0.903 |
| 36 | 6 | 1.0 | Insoluble | Lanthanum hydroxide | 130 | 144 | 160 | 150 | 0.948 |
| 37 | 4 | 1.0 | Insoluble | Lanthanum hydroxide | 130 | 125 | 138 | 164 | 0.897 |
| 38 | 6 | 1.0 | Insoluble | Lanthanum hydroxide | 130 | 127 | 155 | 150 | 0.999 |
| 39 | 6 | 3.0 | Insoluble | Lanthanum hydroxide | 130 | 105 | 145 | 167 | 0.744 |
| 40 | 4 | 1.0 | Insoluble | Lanthanum hydroxide - Molycorp | 130 | 90 | 127 | 168 | 0.754 |
| 41 | 4 | 1.0 | Insoluble | Lanthanum hydroxide - Molycorp | 130 | 101 | 135 | 165 | 0.895 |
| 42 | 6 | 1.0 | Insoluble | Lanthanum oxide | 130 | 145 | 153 | 149 | 0.996 |
| 43 | 4 | 1.0 | Insoluble | Lanthanum oxide | 130 | 142 | 146 | 156 | 1.009 |
| 44 | 4 | 1.0 | Insoluble | Lanthanum oxide - Molycorp | 130 | 107 | 131 | 170 | 0.945 |
| 45 | 4 | 1.0 | Insoluble | Lanthanum oxide - Molycorp | 130 | 145 | 157 | 162 | 1.072 |
| 46 | 6 | 1.0 | Insoluble | Lanthanum oxide - Molycorp | 110 | 117 | 117 | 172 | 1.071 |
| 47 | 6 | 3.0 | Insoluble | Lanthanum oxide - Molycorp | 110 | 107 | 117 | 181 | 1.000 |
| 48 | 4 | 3.0 | Insoluble | Lanthanum oxide - Molycorp | 130 | 154 | 153 | 152 | 1.010 |
| 49 | 6 | 14% | Insoluble | SnO2 | 130 | | | 137 | 0.900 |
| 50 | 6 | 14% | Insoluble | SnO2 | 130 | | | 137 | 0.900 |

| | | 1200° C./4 hours | | 1200° C./24 hours | | | | |
|---|---|---|---|---|---|---|---|---|
| | Water | Surface | Pore | Surface | Pore | Alpha | | |
| Test | Dispersibility | Area | Volume | Area | Volume | Conversion | Slurry | |
| ID | % | m2/g | ml/g | m2/g | ml/g | ° C. | pH | pKsp |
| 1 | 98.5 | 69 | 0.777 | 49 | 0.535 | 1352 | | |
| 2 | 96.1 | 34 | 0.345 | 7 | 0.029 | 1295 | | |
| 3 | 0.0 | 63 | 0.636 | 49 | 0.504 | 1366 | | |
| 4 | | 52 | 0.458 | 8 | 0.036 | 1364 | | |
| 5 | 0.0 | 63 | 0.865 | 59 | 0.705 | >1400 | 10.83 | |
| 6 | 98.0 | 74 | 0.935 | 66 | 0.857 | >1400 | | |
| 7 | 0.0 | 85 | 0.816 | 71 | 0.728 | 1324 | | |
| 8 | | | | | | 1336 | | |
| 9 | 0.0 | 54 | 0.522 | 27 | 0.265 | 1362 | 10.11 | |
| 10 | 0.0 | 68 | 0.778 | 64 | 0.748 | >1400 | 10.92 | |
| 11 | 0.0 | 69 | 0.818 | 63 | 0.740 | >1400 | | |
| 12 | 0.0 | 78 | 0.842 | 68 | 0.749 | >1400 | 10.92 | |
| 13 | 0.0 | 27 | 0.195 | 25 | 0.243 | 1249 | | 5.1 |
| 14 | 0.0 | 17 | 0.185 | 6 | 0.041 | 1316 | 10.03 | |
| 15 | 98.9 | 51 | 0.526 | 5 | 0.016 | 1330 | 7.50 | 33 |
| 16 | 95.8 | 37 | 0.409 | 6 | 0.013 | 1351 | 6.5-7.5 | |
| 17 | 95.8 | 34 | 0.273 | 6 | 0.014 | | 6.5-7.5 | |
| 18 | 95.8 | 60 | 0.534 | 8 | 0.377 | | 6.5-7.5 | |
| 19 | 95.8 | 32 | 0.319 | 6 | 0.019 | 1347 | 6.5-7.5 | |
| 20 | 95.8 | 55 | 0.482 | 9 | 0.051 | 1365 | 6.5-7.5 | |
| 21 | 95.8 | 52 | 0.465 | 7 | 0.043 | 1365 | 6.5-7.5 | |
| 22 | 97.3 | 65 | 0.709 | 34 | 0.385 | 1401 | 6.5-7.5 | |
| 23 | 97.1 | 58 | 0.549 | 6 | 0.021 | 1368 | 6.5-7.5 | |
| 24 | | 41 | 0.398 | 6 | 0.023 | 1354 | 6.5-7.5 | |
| 25 | | 9 | 0.024 | 5 | 0.010 | 1295 | 7.90 | |
| 26 | 91.3 | 65 | 0.695 | 44 | 0.488 | 1383 | | 18.7 |
| 27 | 96.8 | 57 | 0.475 | 11 | 0.037 | 1324 | | |
| 28 | 96.1 | 65 | 0.695 | 44 | 0.488 | 1375 | | |
| 29 | 99.2 | 54 | 0.451 | 31 | 0.362 | 1360 | 8.23 | |
| 30 | 97.0 | 62 | 0.522 | 31 | 0.249 | 1320 | | |
| 31 | 77.2 | 62 | 0.531 | 34 | 0.321 | | | |
| 32 | 77.2 | 62 | 0.543 | 33 | 0.288 | | | |
| 33 | 77.2 | 64 | 0.582 | 32 | 0.299 | | | |
| 34 | 77.2 | 65 | 0.614 | 23 | 0.213 | | | |
| 35 | 77.2 | 63 | 0.584 | 41 | 0.391 | | | |
| 36 | 77.2 | 65 | 0.598 | 17 | 0.147 | | | |
| 37 | | 65 | 0.51 | 30 | 0.372 | 1392 | | |
| 38 | 97.8 | 66 | 0.602 | 48 | 0.474 | 1364 | | |
| 39 | 97.2 | 57 | 0.481 | 37 | 0.299 | 1381 | | |
| 40 | | 59 | 0.396 | 17 | 0.287 | | | |
| 41 | | 64 | 0.512 | 24 | 0.21 | | | |
| 42 | | 68 | 0.649 | 49 | 0.478 | 1376 | | |
| 43 | | 71 | 0.632 | 58 | 0.52 | 1377 | | |
| 44 | | 68 | 0.548 | 9 | 0.192 | | | |
| 45 | | 79 | 0.7439 | 67 | 0.635 | | | |
| 46 | | | | | | | | |
| 47 | | | | | | | | |
| 48 | | | | | | | | |
| 49 | | | | | | | | |
| 50 | | | | | | | | |

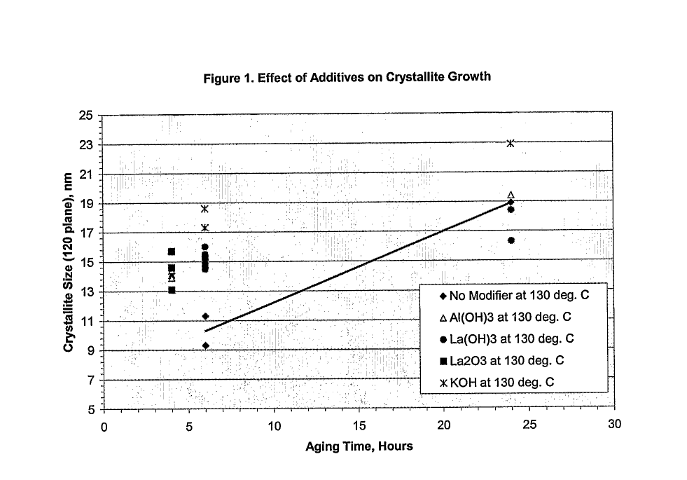

The advantages of the present invention can be seen with reference to the various figures which graphically depict the data in Table 2. Referring first to FIG. 1, there is shown the effect of the additives or modifier on crystallite growth. As can be seen with respect to FIG. 1 and with particular reference to the use of lanthanum oxide, without the use of the modifiers of the present invention, it would take in excess of 15 hours of aging time to achieve the same crystallite growth that is achieved in less than 5 hours according to the process of the present invention. As FIG. 1 also shows, water soluble modifiers such as KOH, also dramatically increase the rate at which the desired crystal growth is achieved. However, as will be shown hereafter, the use of potassium hydroxide or similar water soluble hydroxides has a deleterious effect on viscosity.

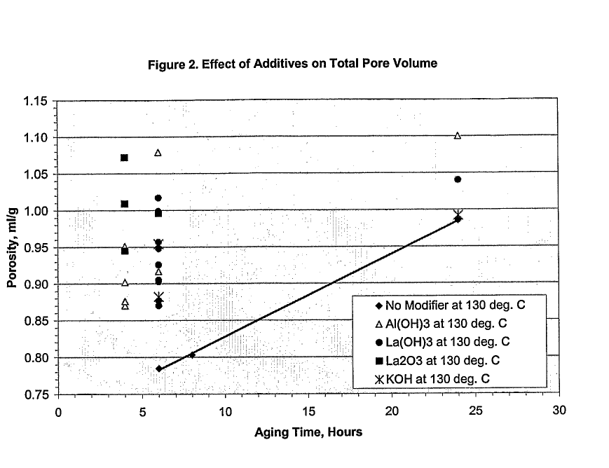

Turning to FIG. 2, the effect of using the additives of the present invention, as well as water soluble additives, on total pore volume is depicted. Basically, FIG. 2 shows the same effect as FIG. 1 vis-a-vis aging time to achieve desired pore volume.

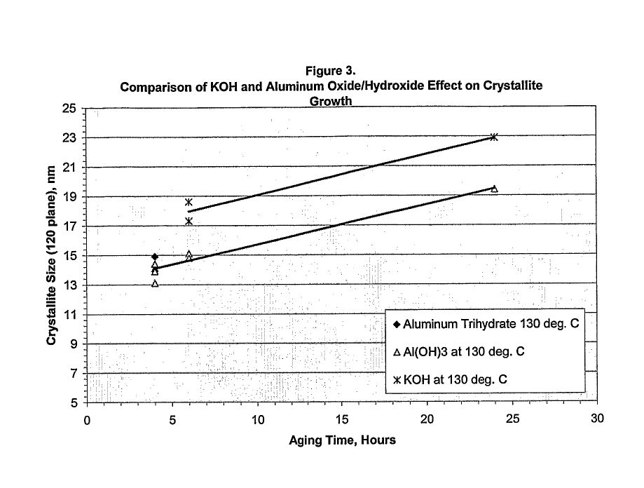

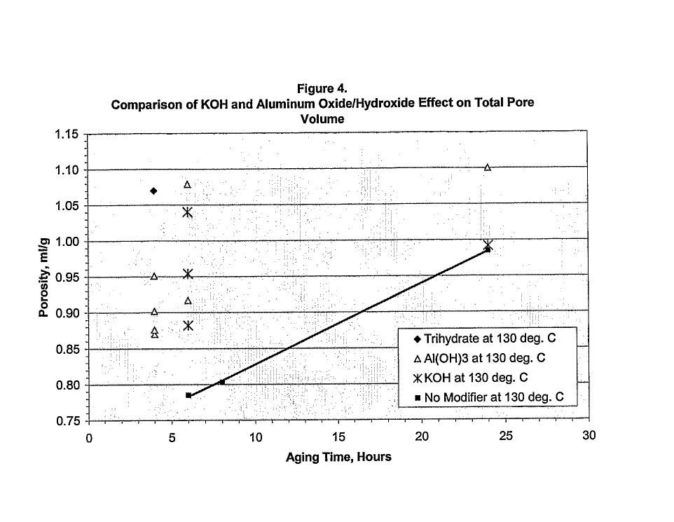

Whether the oxide or hydroxide is soluble or insoluble is not critical in determining its effectiveness in promoting crystallite growth or development of porosity as seen in FIGS. 1 and 2. In fact, as seen above, the insoluble aluminum hydroxide gives better porosity at the same aging time as soluble potassium hydroxide. FIGS. 3 and 4 below show that while a soluble hydroxide, i.e., potassium hydroxide, gives faster crystallite development (FIG. 3), porosity enhancement is comparable at short aging times and better at long aging times using aluminum trihydrate or aluminum hydroxide (FIG. 4).

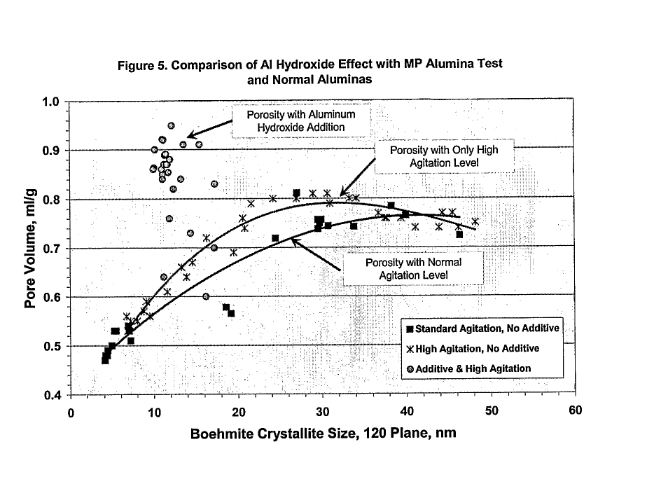

FIG. 5 graphically depicts the synergistic effect between the additives and the agitation energy. When only high agitation energy, about 10 kW/m³, is used in the process a medium porosity alumina is obtained. As shown in FIG. 5, when an additive according to the present invention is added to the feed slurry in combination with high agitation energy, the porosity is much greater than can be obtained without the additive. As can be seen, total pore volumes can be up to 50% greater using the aluminum hydroxide as compared with just agitation alone. Effectively, there is synergism between the use of the additives of the present invention and effective energy consumption. It is well known that total pore volume varies as a function of the crystallinity of boehmite alumina. FIG. 5 demonstrates that at the same crystallite size, the porosity of alumina produced according to this invention is increased by as much as 50% over aluminas produced at normal or high agitation levels without addition of the additives demonstrated in this invention. All results are at 2.3 hours aging time.

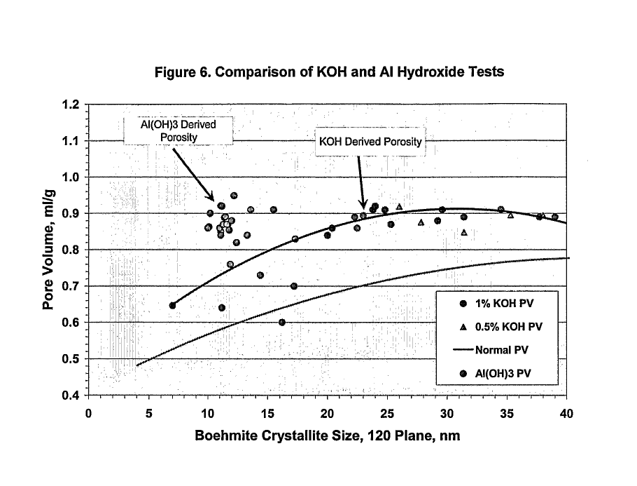

FIG. 6 shows a similar comparison with respect to the use of soluble potassium hydroxide. In the case of the data depicted in FIG. 6, the residence time and agitation conditions are the same for the three sets of additives. Note that the addition of alumina hydroxide produced a high porosity alumina at a crystallite size below that which can be produced using potassium hydroxide. To make these low crystallite sizes, the reactor temperature must be relatively cool. When operated in this relatively low temperature range, potassium hydroxide makes the alumina slurry too viscous to process.

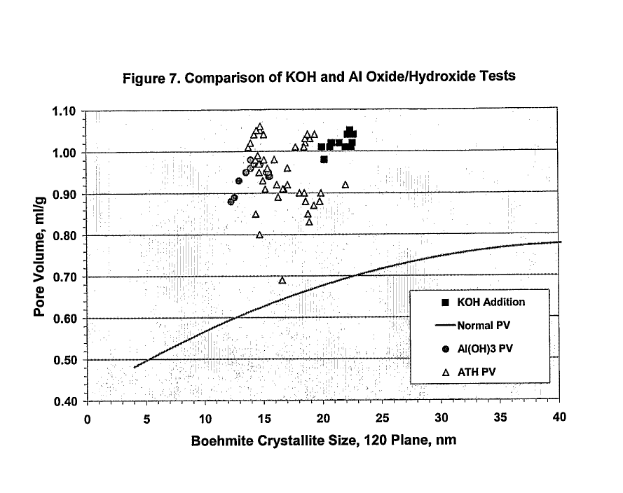

FIG. 7 compares both the effect of adding aluminum hydroxide/oxide with potassium hydroxide and longer residence times than depicted in the previous two figures. Again, the use of the insoluble additives (aluminum hydroxide or aluminum trihydrate, ATH) produce results which are comparable to those obtained with the use of potassium hydroxide. However, as noted above, the use of additives such as aluminum hydroxide, alumina oxides or aluminum trihydrates does not result in undesirable increase in slurry viscosity in the reactor as is the case with the use of potassium hydroxide. Additionally, the insoluble additives of the present invention permit the production of smaller crystallite size high porosity aluminas than does the use of potassium hydroxide.

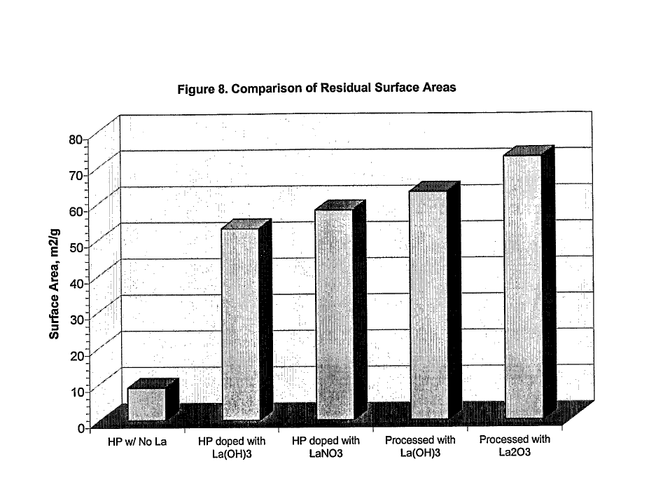

As noted above, certain of the modifiers of the present invention can be used to produce aluminas which have a high degree of thermal stability. It is well known that a high porosity alumina can be doped with lanthanum in an additional step, i.e., after hydrothermal aging, and then calcined to produce a gamma phase alumina suitable for high temperature catalyst supports, e.g., catalytic converter supports. However, in the process of the present invention wherein an insoluble lanthanum compound is added prior to or during the hydrothermal aging, meaning that the subsequent step of combining a high porosity alumina with a water soluble lanthanum compound is unnecessary. Indeed, it appears that there is a synergy between the development of the high porosity and the increase in thermal stability of the subsequently produced gamma alumina produced from the boehmite according to the present invention. Thus a gamma alumina product produced using the process of the present invention has thermal stability equal to or greater than that used in the two-step doping process. Additionally, using the process of the present invention, calcination to achieve the gamma phase does not result in the emission of nitrogen oxides, hydrocarbon compounds or other gases that are released using traditional doping with water soluble lanthanum compounds. Thus, the present invention not only provides a process for making a high porosity alumina but, if the proper additive is chosen, the thermal stability of subsequently produced gamma aluminas is as good or better than that obtained with conventional doping processes involving subsequent steps. FIG. 8 shows the surface area of various aluminas after they have been calcined at 1200EC for 24 hours. The surface area of calcined aluminas following calcination at the temperature and time listed above is referred to as Residual Surface Area. As can be seen, undoped high porosity aluminas (HP aluminas) do have enhanced thermal stability, but under the stringent testing applied herein, they lose most of their surface area as shown in FIG. 8. As FIG. 8 also shows, if the HP aluminas are doped after they have been produced, aluminas of High Residual Surface Area can be obtained, using either lanthanum nitrate or lanthanum hydroxide as the doping. As FIG. 8 further shows, using the process of the present invention wherein the lanthanum hydroxide is added to the feed slurry prior to or during hydrothermal aging, the high porosity aluminas produced have Residual Surface Areas that are comparable to post doped high porosity aluminas. As seen, the porosities of the aluminas are all greater than or equal to 1.0 ml/g. At lower porosity, aluminas tend to have lower stability as can be seen in Table 2.

### Example 3

This example demonstrates the effect on pH of adding water soluble hydroxide and the modifiers of the present invention to alumina slurries that are to be hydrothermally treated. In all cases, the additives were added at a 1% wt. level. The results are shown in Table 3 below:

TABLE 3

| Additive | Slurry pH |
|---|---|
| Slurry with no Additive | 9.38 |
| KOH | 11.97 |
| Al(OH)₃ commercial grade | 8.70 |
| Crystalline Aluminum | 9.35 |
| Trihydrate | |
| Lanthanum Oxide | 9.33 |
| Tin (IV) Oxide | 9.35 |
| Ammonium Hydroxide | 10.73 |
| Slurry with no Additive | 9.53 |
| Al(OH)₃ laboratory grade | 9.20 |

As can be seen from the data in Table 3, the addition of water soluble hydroxides such as potassium hydroxide or ammonium hydroxide, has a dramatic effect on the slurry pH. This is to be compared with the use of the additives of the present invention which essentially have no effect on pH. Although Table 3 does show that the addition of aluminum hydroxide does lower the pH by about 0.3 to 0.6 units, it is to be understood that aluminum hydroxide which contains aluminum hydroxy carbonate as an impurity. Aluminum hydroxy carbonate is acidic which accounts for the drop in pH. However, if the aluminum hydroxide were free of the carbonate impurity, there would be little, if any, change in the pH.

### Example 4

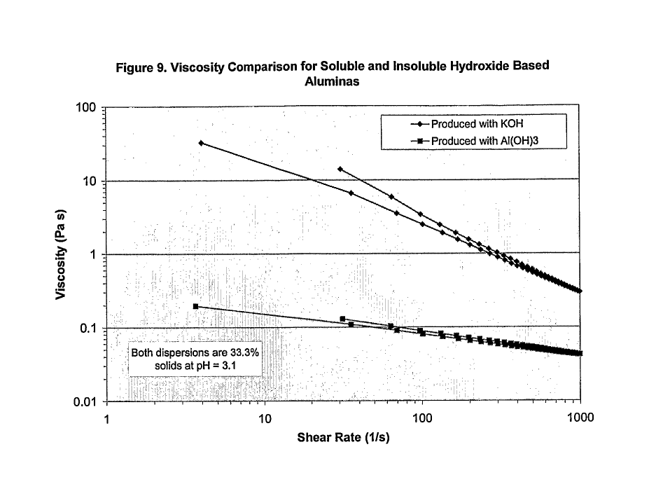

This example demonstrates the effect on viscosity of two water dispersed aluminas using a water soluble hydroxide and an insoluble hydroxide according to the present invention. The water dispersion contained 33.3% wt. alumina calculated as Al₂O₃, and lactic acid was used to adjust the pH of both to about 3.1. Although as can be seen from the data in Table 4, the two aluminas have similar properties, it was found that the dispersion of the alumina made using potassium hydroxide had significantly higher viscosity than the dispersion made using the crystalline aluminum trihydrate. The relevant viscosity data is shown in FIG. 9.

TABLE 4

| | | |
|---|---|---|
| Surface | Pore | Crystallite Size |
| Area | Volume | (Angstroms) |

| Additive | (m²/g) | (ml/g) | 020 Reflex | 120 Reflex |
|---|---|---|---|---|
| KOH | 144 | 1.04 | 201 | 222 |
| Crystalline | 147 | 1.03 | 173 | 190 |
| Aluminum | | | | |
| Trihydrate | | | | |

Representative but non-limiting applications for the compositions obtained by this process includes catalysts and catalyst supports; coatings; adsorbents; surface treatments; ceramics and refractories; reinforcement of ceramics, metals, plastics and elastomers; scratch resistant coatings; agents for the delivery of pharmaceutically active materials; thickening agents and rheology modifiers; rinse aids; fabric treatment; paper treatment; inkjet recording media; soil resistant coatings; and barrier coatings.

The foregoing description and examples illustrate selected embodiments of the present invention. In light thereof, variations and modifications will be suggested to one skilled in the art, all of which are in the spirit and purview of this invention.

What is claimed is:

1. A method for producing high porosity boehmite alumina comprising:
mixing an aqueous boehmite alumina slurry with an effective amount of a modifier comprising a hydroxide or oxide of an element of Group IIIA-VIII of the Periodic Table of Elements and having a pKsp of greater than 11 to produce a precursor mixture; and
hydrothermally aging said precursor mixture at a temperature in the range of 100-160° C. under agitation with an effective consumptive power of greater than 1 kW/m³.

2. The method of claim 1, wherein the consumptive power is from 5-12 kW/m³.

3. The method of claim 1, wherein the pH of said precursor mixture is from 8-10.

4. The method of claim 1, wherein said modifier is present in an amount of from 0.1 to 5 wt. % based on the alumina content of the precursor mixture.

5. The method of claim 1, wherein said hydrothermal aging is conducted for a period of time ranging from 1 hour to 24 hours.

6. The method of claim 1, wherein said modifier is mixed with said aqueous boehmite alumina slurry prior to said hydrothermal aging.

7. The method of claim 1, wherein said modifier is mixed with said aqueous boehmite slurry during said hydrothermal aging.

8. The method of claim 1, wherein said modifier does not alter the pH of the precursor mixture by more than 0.2 pH units.

9. The method of claim 1, wherein said modifier is lanthanum oxide or hydroxide.

10. The method of claim 1, wherein said boehmite alumina is obtained by hydrolysis of an aluminum alkoxide.

11. A method for producing a thermally stable gamma alumina comprising:
mixing an aqueous boehmite alumina slurry with an effective amount of a modifier comprising a water insoluble hydroxide or oxide of an element of group IIIA-8 of the Periodic Table of Elements and having a pKsp of greater than 11 to produce a precursor mixture;
hydrothermally aging said precursor mixture at a temperature in the range of 100-160° C. under agitation with an effective consumptive power of greater than 1 kW/m³ to produce a modified boehmite alumina; and
calcining said modified boehmite alumina.

12. The method of claim 11, wherein the consumptive power is from 5-12 kW/m³.

13. The method of claim 11, wherein the pH of said precursor mixture is from 8-10.

14. The method of claim 11, wherein said modifier is present in an amount of from 0.1 to 5 wt. % based on the alumina content of the precursor mixture.

15. The method of claim 11, wherein said hydrothermal aging is conducted for a period of time ranging from 1 hour to 24 hours.

16. The method of claim 11, wherein said modifier is mixed with said aqueous boehmite alumina slurry prior to said hydrothermal aging.

17. The method of claim 11, wherein said modifier is mixed with said aqueous boehmite slurry during said hydrothermal aging.

18. The method of claim 11, wherein said modifier does not alter the pH of the precursor mixture by more than 0.2 pH units.

19. The method of claim 11, wherein said modifier is lanthanum oxide or hydroxide.

20. The method of claim 11, wherein said boehmite alumina is obtained by hydrolysis of an aluminum alkoxide.
